(19) United States
(12) Patent Application Publication
(10) Pub. No.: US 2004/0085590 A1
(43) Pub. Date: May 6, 2004

(54) Modifying an image based on image quality

(76) Inventor: Kurt Thiessen, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/285,128

(22) Filed: Oct. 31, 2002

(51) Int. Cl. H04N 1/409; G06K 15/02; H04N 1/387

(52) U.S. Cl. 358/3.24; 382/112; 358/3.26; 358/1.11; 358/1.2

(57) ABSTRACT

A method for printing includes printing an image on media and generating data related to image quality, with the data to indicate whether the image quality within a first area of the media has deteriorated. In addition, the method includes modifying the image based on the data so that the image is no longer printed within the first area if the data indicates deterioration.

### BACKGROUND

For some printing operations in the business environment, correct operation of a printer permits continued operation of the business. For example, in a point of sale application a failure in a receipt printer may result in a merchant halting further transactions until the receipt printer is fixed. This can cause a business disruption and loss of revenue.

For multi-pass printers using moving printheads, drop detection and/or missing nozzle detection can be used for print quality monitoring. When errors are detected they can sometimes be corrected by adjusting what is printed in each pass of the multi-pass printing process. However, this is only effective in multi-pass printing operations where several printing passes are performed. However, in printers that make use of single pass printing, such as many receipt printers, single pass printing is performed using fixed printheads with only one pass of the media through the printing mechanism. In this case, multiple passes are not available to correct image flaws.

### SUMMARY OF THE INVENTION

A method for printing includes printing an image on media and generating data related to image quality, with the data to indicate whether the image quality within a first area of the media has deteriorated. In addition, the method includes modifying the image based on the data so that the image is no longer printed within the first area if the data indicates deterioration.

### BRIEF DESCRIPTION OF THE DRAWINGS

FIG. 1 is a simplified block diagram of a printer operating in accordance with a preferred embodiment of the present invention.

FIG. 2 is a simplified flowchart that illustrates decision making within a printer operating in accordance with a preferred embodiment of the present invention.

FIG. 3 is an example of a printer malfunction.

FIG. 4 is an example of a correction to the printer malfunction shown in FIG. 3 in accordance with a preferred embodiment of the present invention.

FIG. 5 is another example of a printer malfunction.

FIG. 6 is an example of a correction to the printer malfunction shown in FIG. 5 in accordance with a preferred embodiment of the present invention.

### DESCRIPTION OF THE PREFERRED EMBODIMENT

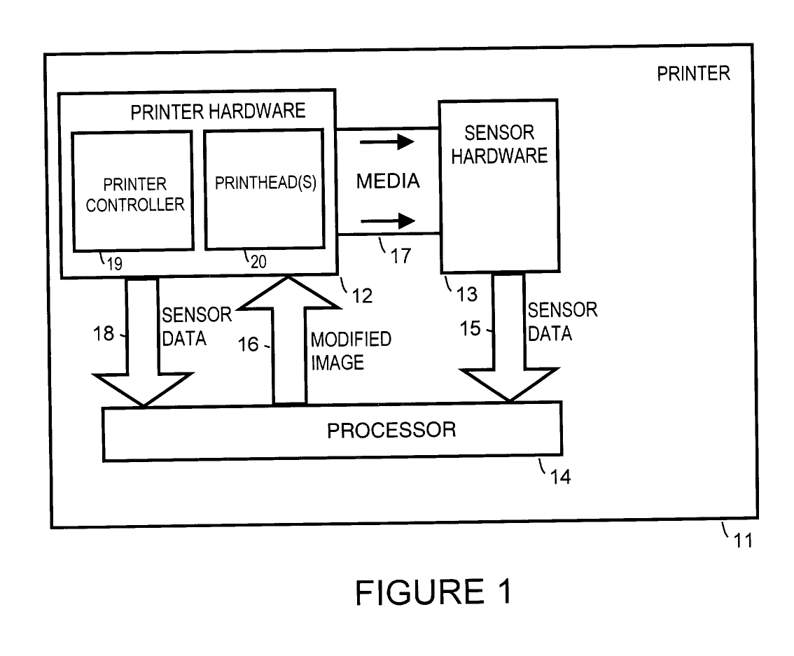

FIG. 1 is a simplified block diagram of a printer. Printer hardware 12 prints on media 17 moving in a direction indicated by the arrows on media 17. Printer hardware 12 includes a printer controller 19. Printer hardware 12 also includes one or more printhead(s) 20.

Printer Sensor hardware 13 scans media 17 to verify proper operation of printer hardware 12. Sensor hardware 13 forwards sensor data 15 to a processor 14. When sensor data 15 indicates that at least a partial failure of printer hardware 12 has occurred, processor 14 will evaluate whether the failure can be temporarily remedied by modifying printing images. If so, processor 14 sends modified image information 1 to printer hardware 12 that continues to print on media 17 based on modified image information 16. Likewise, when sensor data 18 indicates that at least a partial failure of printer hardware 12 has occurred, processor 14 will evaluate whether the failure can be temporarily remedied by modifying printing images. If so, processor 14 sends modified image information 16 to printer hardware 12. Printer hardware 12 continues to print on media 17 based on modified image information 16.

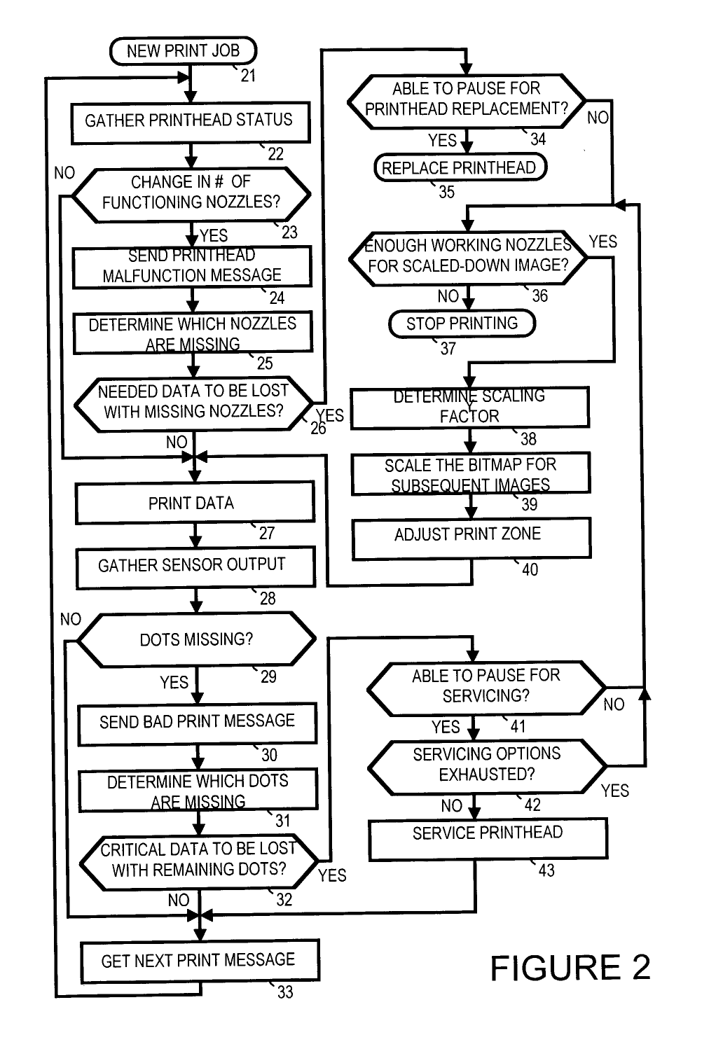

FIG. 2 is a simplified flowchart that illustrates operation of processor 14 in monitoring sensor data 15 and generating modified image information 16. In a block 21 a new print job is started. In a block 22, printhead status 18 is gathered from the printhead controller within printer hardware 12.

In a block 23, processor 14 determines from printhead status 18 whether there has been a change in the number of functioning nozzles. If not, in a block 27, the data is printed.

If in block 23, processor 14 determines from printhead status 18 that there has been a change in the number of functioning nozzles, in a block 24, a printhead malfunction message is sent to the operator. In a step 25, processor 14 determines from the printhead status which nozzles are not functioning.

In a step 26, processor 14 determines whether needed data will be lost printing with the working nozzles. If not, in step 27, the data is printed.

If in step 26, processor 14 determines needed data will be lost printing with the working nozzles, in a step 34, processor 14 ascertains whether it is possible to pause for a printhead replacement. If so, in a step 35, the printhead is replaced.

If in step 34, processor 14 ascertains that it is not possible to pause for a printhead replacement, in a step 36, processor 14 ascertains whether there is enough working nozzles to print a scaled-down image. If not, in a step 37, processor 14 stops the printing process.

If in step 36, processor 14 ascertains there is enough working nozzles to print a scaled-down image, in a step 38, processor 14 determines a scaling factor based on the functioning nozzles. In a step 39, processor 14 scales the bitmap for subsequent images until the nozzles are fixed. In a step 40, processor 14 adjusts the print zone to only include functioning nozzles. Then, in step 27, the data is printed.

In a step 28, processor 14 receives sensor data from sensor hardware 13. In a step 29, processor 14 determines whether there are dots missing from the printing output on media 17. If not, in a step 33, processor 14 gets the next print message (if any).

If in step 29, processor 14 determines there are dots missing from the printing output on media 17, in a step 30, processor 14 sends a “bad print” message to the operator. In a step 31, processor 14 determines from sensor data 15 which dots are missing.

In a block 32, processor 14 ascertains whether needed data will be lost printing with the remaining dots. If not, in a step 33, processor 14 gets the next print message (if any).

If in block 32, processor 14 ascertains needed data will be lost printing with the remaining dots, in a step 41, processor 14 ascertains whether it is possible to pause for servicing. If not, in step 36, processor 14 ascertains whether there is enough working nozzles to print a scaled-down image.

If in step 41, processor 14 determines it is possible to pause for servicing, in a step 42, processor 14 ascertains whether existing service options have been exhausted. If so, in step 36, processor 14 ascertains whether there is enough working nozzles to print a scaled-down image.

If in step 42, processor 14 determines existing service options have not been exhausted, in a step 43 the printhead is serviced. Then, in step 33, processor 14 gets the next print message (if any).

Software that programs processor 14 to implement the steps in the flowchart shown in FIG. 2 can be stored on a storage medium of a variety of types such as floppy disk, hard disk, optical media (e.g., a CD), semiconductor memory or any other non-volatile memory.

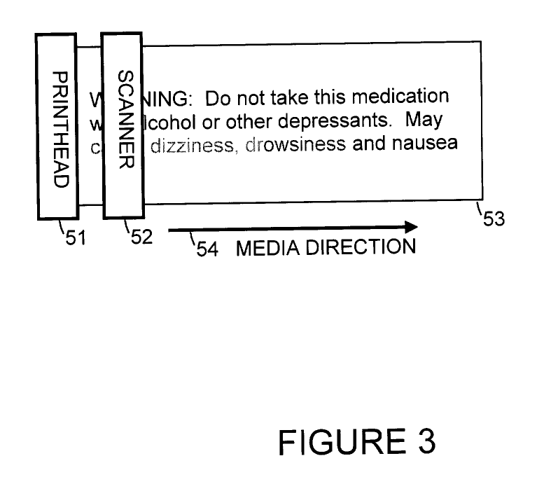

FIG. 3 shows a printhead 51 printing labeling information on media 53. An arrow 54 represents media direction during printing. A scanner 52 scans the print image on media 53 and detects deteriorating print quality on the bottom line of the label.

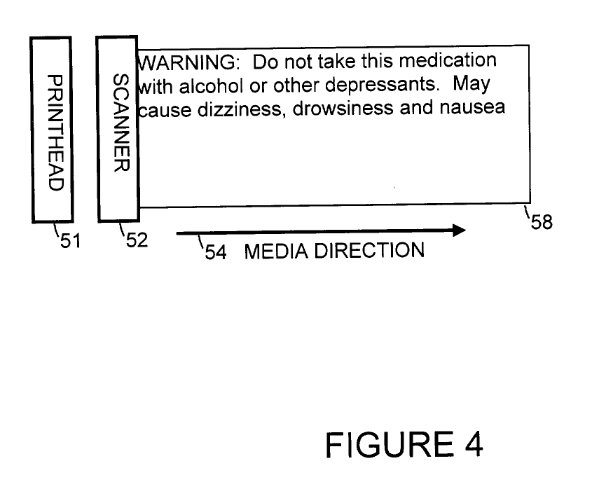

FIG. 4 illustrates the result of a processor, such as processor 14, evaluating and then modifying the print image. As shown in FIG. 4, the writing on media 58 has been moved up so that the nozzles producing the nozzles within printhead 41 causing the deteriorating print quality are no longer used. The malfunctioning portion of printhead 41 remains deactivated until a replacement printhead can be installed. This allows printing to continue without loss of information.

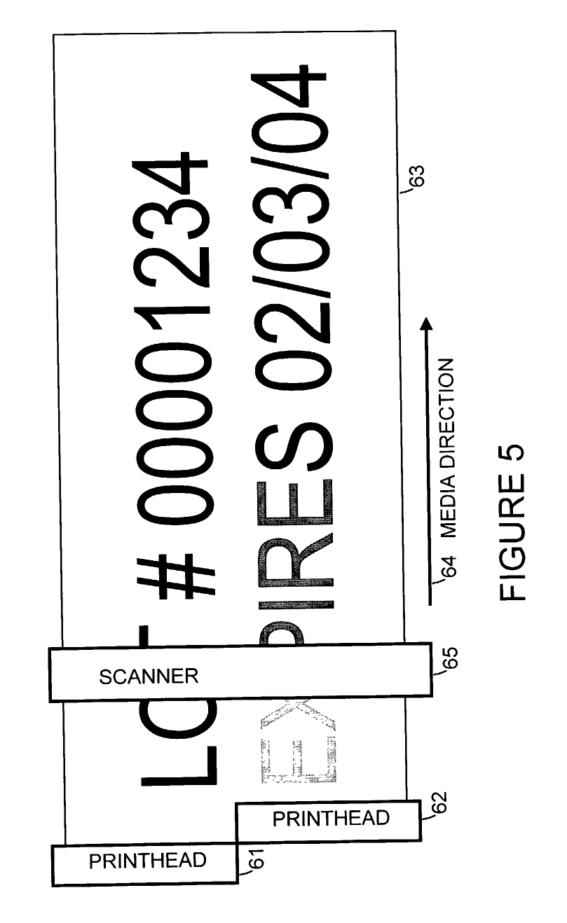

FIG. 5 shows a printhead 61 and a printhead 62 printing on media 63. An arrow 64 represents media direction during printing. A scanner 62 scans the print image on media 53 and detects deteriorating print quality on the portion of the label printed by printhead 62.

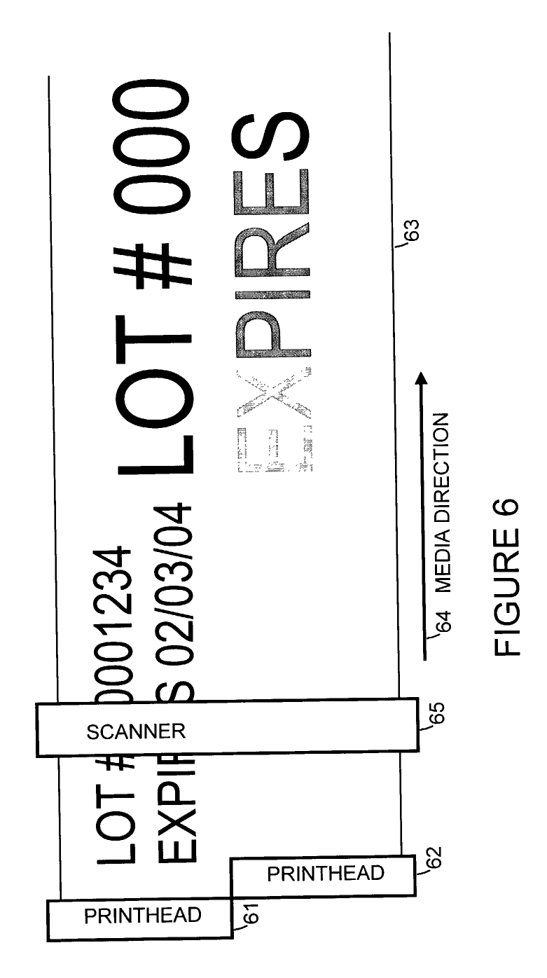

FIG. 6 illustrates the result of a processor such as processor 14 evaluating and then modifying the print image. As shown in FIG. 6, during the print job, the labeling information has been reformatted by condensing the fonts and reprinted on media 63 using only printhead 61. The malfunctioning printhead 62 remains deactivated until a replacement printhead can be installed. This allows printing to continue without loss of information.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A method for printing comprising:
(a) printing an image on media;
(b) generating data related to image quality, the data to indicate whether the image quality within a first area of the media has deteriorated; and,
(c) modifying the image based on the data so that the image is no longer printed within the first area if the data indicates deterioration.

2. A method as in claim 1 wherein in step (c) modifying the image includes changing font size of text.

3. A method as in claim 1 wherein in step (b) the data is generated using a scanning device to scan at least a portion of the image.

4. A method as in claim 1 wherein in step (b) the data is generated using a printer controller monitoring operation of print hardware.

5. A method as in claim 1 wherein in step (c) modifying the image includes scaling a bit map for the image.

6. A method as in claim 1 additionally comprising:
(d) notifying a user when the image quality within the first portion of the first area of the media has deteriorated.

7. A method as in claim 1 wherein in step (b) the data is generated using a scanning device to scan at least a portion of the image and using a printer controller monitoring operation of print hardware.

8. A printing device comprising:
printer hardware to print an image on media;
a sensing device to generate data on print quality, the data indicating when print quality within a first area of the media has deteriorated; and
a processing device to modify the image based on the data so that the image is no longer printed within the first area of the media when print quality within the first area of the media has deteriorated.

9. A printing device as in claim 8 wherein the processing device modifies the image by changing font size of text.

10. A printing device as in claim 8 wherein the sensing device includes a scanner that scans the image.

11. A printing device as in claim 8 wherein the sensing device includes a printer controller that monitors operation of print hardware.

12. A printing device as in claim 8 wherein the sensing device includes a scanner that scans the image and a printer controller that monitors operation of the printer hardware.

13. A printing device as in claim 8 wherein the processing device modifies the image by scaling a bit map for the image.

14. A printing device as in claim 8 wherein the processing device notifies a user when print quality within the first portion of the first zone has deteriorated.

15. A printing device comprising:
printer means for printing images on media;
sensing means for generating data on print quality, the data on print quality indicating when print quality within a first area of the media has deteriorated; and,
processing means for modifying the print image based on the data on print quality so that the print image is no longer printed within the first area of the media when print quality within the first area of the media has deteriorated.

16. A printing device as in claim 15 wherein the processing means modifies the print image by changing font size of text.

17. A printing device as in claim 15 wherein the sensing means includes a scanner that scans the print image.

18. A printing device as in claim 15 wherein the sensing means includes a printer controller that monitors operation of print hardware.

19. A printing device as in claim 15 wherein the sensing means includes a scanner that scans the print image and a printer controller that monitors operation of print hardware.

20. A printing device as in claim 15 wherein the processing means modifies the print image by scaling a bit map for the print image.

21. Storage media that stores a program, which when executed performs a method comprising:
(a) receiving data related to print quality of an image printed on media, the data indicating whether the print quality within a first area of the media has deteriorated; and,
(b) modifying the image based on the data so that the image is no longer printed within the first area of the media if the print quality within the first area of the media has deteriorated.

22. Storage media as in claim 21 wherein in step (b) modifying the image includes changing font size of text.

23. Storage media as in claim 21 wherein in step (a) the data on print quality is received from a scanning device that scans at least a portion of the image.

24. Storage media as in claim 21 wherein in step (a) the data on print quality is received from a printer controller monitoring operation of print hardware.

25. Storage media as in claim 21 wherein in step (b) modifying the image includes scaling a bit map for the image.

26. Storage media as in claim 21 wherein the method additionally comprises:
(c) notifying a user when print quality within the first portion of the first area of the media has deteriorated.

27. An apparatus comprising:
a sensing device to generate data on print quality of an image printed on media, the data indicating when print quality within a first area of the media has deteriorated; and,
a processing device to modify the image based on the data so that the image is no longer printed within the first area of the media when print quality within the first area of the media has deteriorated.

28. An apparatus as in claim 27 wherein the processing device modifies the image by changing font size of text.

29. An apparatus as in claim 27 wherein the processing device modifies the image by scaling a bit map for the image.

30. An apparatus as in claim 27 wherein the processing device notifies a user when print quality within the first portion of the first zone has deteriorated.
